(19) United States
(12) Patent Application Publication
(10) Pub. No.: US 2016/0286513 A1
(43) Pub. Date: Sep. 29, 2016

(54) TIME-VARYING CHANNEL DISCRIMINATING DEVICE AND METHOD THEREOF

(71) Applicant: MStar Semiconductor, Inc., Hsinchu Hsien (TW)

(72) Inventors: Fong-Shih Wei, Zhubei City (TW); Cheng-Han Wu, Zhubei City (TW); Tai-Lai Tung, Zhubei City (TW)

(21) Appl. No.: 15/078,557

(22) Filed: Mar. 23, 2016

(30) Foreign Application Priority Data
Mar. 26, 2015 (TW) 104109736

(51) Int. Cl. H04W 56/00; H04L 25/02

(52) U.S. Cl. CPC H04W 56/0035; H04W 56/001; H04L 25/0228

(57) ABSTRACT

A time-varying channel discriminating device capable of determining whether a wireless communication channel is time-varying is provided. The time-varying channel discriminating device includes: a channel response estimating circuit, estimating a channel response of a baseband signal at a plurality of time points to generate a plurality of estimated channel responses; a transforming unit, transforming the estimated channel responses to generate a plurality of estimated channel frequency responses; a calculating unit, calculating a plurality of calculated values according to the estimated channel frequency responses; and a determining module, determining a channel state corresponding to the baseband signal according to the calculated values.

This application claims the benefit of Taiwan application Serial No. 104109736, filed Mar. 26, 2015, the subject matter of which is incorporated herein by reference.

### BACKGROUND OF THE INVENTION

1. Field of the Invention

The invention relates in general to a time-varying channel discriminating device and a method thereof, and more particularly to a time-varying channel discriminating device capable of determining whether a wireless communication channel is time-varying and a method thereof.

2. Description of the Related Art

In a wireless communication channel, a transmitted signal arrives at a receiving antenna via different paths. By arriving at the receiving antenna via different paths, different relative delay periods, gains and receiving phases are caused, hence forming a multipath channel effect. When a receiver and a base station are relatively still or have extremely low relative moving speeds, parameters including relative delay periods, gains and receiving phases hardly vary with the time, and such channel is referred to as a static channel. However, as relative moving speeds of a receiver and a base station increase, the relative delay periods, gains and receiving phases of a received signal vary with the time, and trigger a Doppler spread effect, and such channel is referred to as a time-varying channel or a dynamic channel.

One significance of a dynamic channel is that, characteristics of a channel through which a signal passes vary with the time, in a way that the signal becomes attenuated and distorted. At this point, the receiver needs to compensate and detect the signal by using channel information. In known technologies, a receiver circuit utilizes a correlation calculator to perform a correlation calculation on an estimated channel response generated by a channel estimator, and transforms a correlation calculation result from the time domain to the frequency domain. A Doppler frequency calculator then calculates the frequency-domain correlation calculation result to obtain a Doppler frequency and a Doppler spectrum to accordingly analyze conditions of the time-varying channel. Details of the Doppler frequency calculation and operation are known to one person skilled in the art and shall be omitted herein. Some drawbacks of such known technology are that, the channel estimator needs to collect signals for a longer period in order to estimate the channel response, and the computation amounts of the correlation calculation of the correlation calculator and the Doppler frequency calculation of the Doppler frequency calculator are extremely high. Further, there are other issues including complexities and a long calculation time of the Doppler frequency calculation. Thus, the above conventional solution is uneconomical from both system cost and system performance aspects.

### SUMMARY OF THE INVENTION

The invention is directed to a time-varying channel discriminating device and a time-varying channel discriminating method for determining whether a wireless channel is time-varying.

The present invention discloses a time-varying channel discriminating device. The time-varying channel discriminating device according to an embodiment of the present invention includes: a channel response estimating circuit, estimating a channel response of a baseband signal at a plurality of time points to generate plurality of estimated channel responses; a transforming unit, transforming the estimated channel responses from the time domain to the frequency domain to generate a plurality of estimated channel frequency responses; a calculating unit, calculating a plurality of calculated values according to the estimated channel frequency responses; and a determining module, determining a channel state corresponding to the baseband signal according to the calculated values.

The present invention further discloses a time-varying channel discriminating method that is performed by a receiver in a wireless communication system. The time-varying channel discriminating method includes steps of: receiving a baseband signal and estimating a channel response of the baseband signal at different time points to generate a plurality of estimated channel responses; transforming the estimated channel responses from the time domain to the frequency domain to generate a plurality of estimated channel frequency responses; calculating a plurality of calculated values according to the estimated channel frequency responses; and determining a channel state corresponding to the baseband signal according to the calculated values.

In the time-varying channel discriminating device and method of the present invention, estimated channel responses are generated by the channel response estimating circuit in a receiver of a wireless communication system, and characteristics that the estimated channel responses display on a spectrum are observed, analyzed, compared and statistically calculated to determine whether the channel is time-varying. Compared to the prior art, the calculation method of the present invention not only is simple, but also involves a low system computation amount and consumes a shorter calculation time. Thus, the wireless communication system is allowed to determine the channel state by a more economical approach and to correspondingly adjust the system.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a time-varying discriminating device according to a first embodiment of the present invention;

FIG. 2 is a schematic diagram of a time-varying discriminating device according to a second embodiment of the present invention;

FIG. 3 is a schematic diagram of a time-varying discriminating device according to a third embodiment of the present invention; and

FIG. 4 is a flowchart of a time-varying channel discriminating method according to an embodiment of the present invention.

### DETAILED DESCRIPTION OF THE INVENTION

The disclosure of the application includes a time-varying channel discriminating device and method capable of determining whether a channel is time-varying. The device and method may be applied to a wireless communication receiver, e.g., a wireless communication receiver of a digital television, or other orthogonal frequency division multiplexing (OFDM) baseband receivers.

In possible implementation, one person skilled in the art can select equivalents or steps to implement the present invention based on the disclosure of the application. That is, the implementation of the present invention is not limited to the embodiments described in the disclosure.

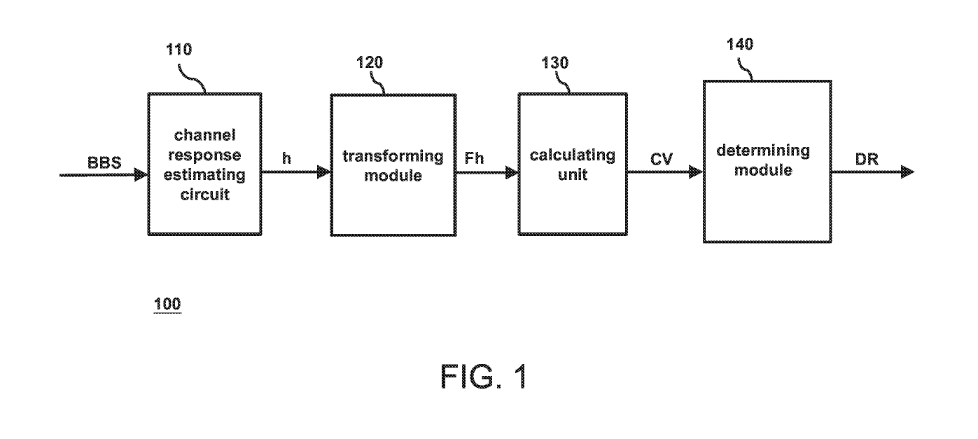

FIG. 1 shows a schematic diagram of a time-varying discriminating device according to a first embodiment of the present invention. A time-varying discriminating device 100 of the embodiment includes an channel response estimating circuit 110, a transforming unit 120, a calculating unit 130 and a determining unit 140. Any two or all of the above circuits may be integrated into one integrated circuit, or may be independent circuits. The time-varying discriminating device 100 of the embodiment may be applied to a receiver in a wireless communication system. For example, the wireless communication system may be a digital audiovisual broadcasting system based on OFDM technologies, e.g., Digital Audio Broadcasting (DAB), Digital Video Broadcasting-Terrestrial/Handheld (DVB-T/H), Integrated Services Digital Broadcasting-Terrestrial (ISDB-T), Digital Radio Mondiale (DRM), HD-Radio, Digital Multimedia Broadcast-Terrestrial/Handheld (DMB-T/H) and Digital Terrestrial Multimedia Broadcast (DTMB). A baseband signal (denoted as BBS in the diagram) received by the time-varying discriminating device 100 of the present invention includes at least one carrier. For example, the baseband signal may be an OFDM signal of a wireless communication system, and includes a plurality of subcarriers that are orthogonal.

Again referring to FIG. 1, the channel response estimating circuit 110 receives a baseband signal. To obtain channel characteristics of a wireless channel that the baseband signal passes through, the channel response estimating circuit 110 estimates a channel response of the baseband signal at a plurality of time points according to the baseband signal to generate a plurality of estimated channel responses (denoted as h in the diagram). In one embodiment, the channel response estimating circuit 110 is a channel estimator adopting pilot-symbol-aided estimation technologies. In one embodiment, the channel response estimating circuit 110 includes a pseudo-noise correlator, which calculates a correlation result of the baseband signal and a pseudo-noise sequence. A frame header of a signal frame of the baseband signal may include a pseudo-noise sequence.

The estimated channel responses generated by the channel response estimating circuit 110 are further inputted into the transforming unit 120. The transforming unit 120 transforms the estimated channel responses from time-domain responses to frequency-domain responses to generate a plurality of estimated channel frequency responses (denoted as Fh in the diagram), so as to accordingly observe spectrum characteristics of the wireless channel. The transforming unit 120 may be implemented by a fast Fourier transform (FFT) unit based on FFT technologies.

The estimated channel frequency responses generated by the transforming unit 120 are inputted into the calculating unit 130. The calculating unit 130 calculates the estimated channel frequency responses generated by the transforming unit 120 to generate a plurality of calculated values (denoted as CV in the diagram). In one embodiment, the calculating unit 130 calculates an energy value of the carrier at each of the time points to generate a plurality of energy values as the above calculated values. The time points may be any time point on a time axis. For example, the energy value may be an energy value of a signal frame of the carrier of the baseband signal. In one embodiment, a square of an absolute value of the estimated channel frequency response is calculated as the energy value. In another embodiment, a square root of an absolute value of the estimated channel frequency response is calculated as the energy value. It should be noted that, the approach for calculating the energy value is not limited to the above examples.

The plurality of calculated values generated by the calculating unit 130 are inputted into the determining module 140. The determining module 140 determines whether the channel corresponding to the baseband signal is in a time-varying channel state according to the calculated values, and generates a determination result (denoted as DR in the diagram). More specifically, the determining module 140 may generate a plurality of ratio relationships according to the calculated values and the respective corresponding time points, compare these ratio relationships with a threshold to generate a plurality of comparison results, and performs a counting operation according to the comparison results to generate the counter values. The counter values may be used to determine whether the channel corresponding to the baseband signal is time-varying.

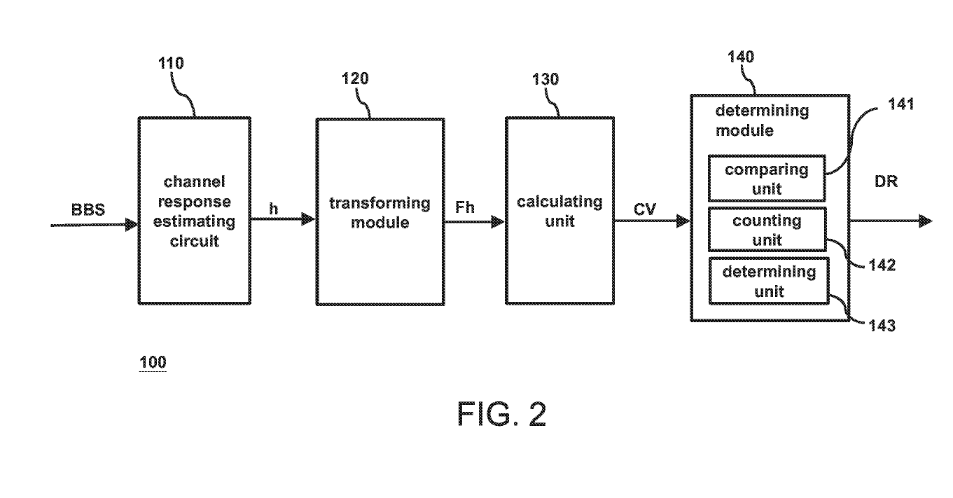

FIG. 2 shows a schematic diagram of the time-varying channel discriminating device 100 in FIG. 1 according to a second embodiment of the present invention. As shown in FIG. 2, the determining unit 140 further includes a comparing unit 141, a counting unit 142 and a determining unit 143. Any two or all of the above circuits may be integrated into one integrated circuit, or may be independent circuits.

Referring to FIG. 2, the calculated values generated by the calculating unit 130 are inputted into the determining module 140. The comparing unit 141 calculates the ratio relationships of the calculated values, and compares the ratio relationships with a threshold. In one embodiment, the ratio relationship is a ratio value between a first calculated value and a second calculated value. For example, the first calculated value is the energy value at a preceding first time point, and the second calculated value is the energy value at a subsequent time point. Further, the calculated value, generated by the calculating unit 130 at the corresponding time point, may be stored in a storage device (e.g., a register, a buffer or a dynamic memory, not shown in the diagram). The comparing unit 141 then compares the ratio value of the corresponding time point with a threshold to generate a comparison result. For example, when the ratio value is a result of the first calculated value divided by the second calculated value, the threshold is a high threshold (e.g., 2), and the comparison result indicates that the ratio value is greater than the high threshold, the first calculated value is greater than the second calculated value by more than two times. Alternatively, when the threshold is a low threshold (e.g., 0.2) and the comparison result indicates that the ratio value is smaller than the low threshold, the first calculated value is smaller than the second calculated value. Thus, by comparing with a predetermined threshold using the comparing unit 141, the ratio relationship between the first calculated value and the second calculated value can be obtained. Further, as the first calculated value and the second calculated value correspond to different time points, respectively, the change values in the first calculated value and the second calculated value corresponding to different time points can be obtained. When the comparison result indicates that the ratio value reaches the threshold, the counting unit 142 adds the current counter value by one. After a period including multiple time points, the determining unit 142 may determine whether wireless channel is time-varying according to the counter value. If the counter value is greater than a predetermined value, it means that, a significant change value exists during the period. Thus, according to the counter value, the determining unit 142 may determine that the wireless channel is time-varying. It should be noted that, the high threshold and the lower threshold may be adopted simultaneously or non-simultaneously. That is, at the same time point or at different time points, the comparing unit 141 may compare whether the second calculated value at a subsequent time point is greater than the first calculated value at a preceding time point, and whether the second calculated value at a subsequent time point is smaller than the first calculated value at a preceding time point. Further, the high threshold and the low threshold may have a corresponding relationship. For example, the high threshold is 1.2, the low threshold is 0.8, and the change value is respectively compared with the high and low thresholds to determine whether the change value is greater by more than 20%. Alternatively, the high threshold and the low threshold may not have a corresponding relationship. For example, the high threshold is 1.4, the low threshold is 0.8, and the change value is respectively compared with the high threshold and the low threshold are compared to determined whether the change value is respectively greater by more than 40% and 20%.

Referring to FIG. 2, operations of the time-varying channel discriminating device 100 is illustrated in an embodiment below. In this embodiment, the time-varying channel discriminating device 100 is located in a receiver of a Digital Terrestrial Multimedia Broadcast (DTMB) system or a Digital Multimedia Broadcast-Terrestrial/Handheld (DMB-T/H) system to receive a baseband signal. The signal includes a four-tier, cyclic structure that is synchronous with the natural time. The signal is in a unit of a frame or a signal frame. On fundamental signal frame is consisted of a frame header and a frame body. The frame header includes a pseudo-noise code, and the frame body is consisted of OFDM symbols. The time-varying channel discriminating device 100 is located in a receiver of a DTMB system or a DMB-T/H system. The channel response estimating circuit 110 receives the baseband signal, and estimates a channel response according to the baseband signal at a first time point to generate a first estimated channel response. The transforming unit 120 transforms the first estimated channel response from a time-domain response to a frequency-domain response to generate a first estimated channel frequency response. The calculating unit 130 calculates a first calculated value according to the first estimated channel frequency response, and stores the first calculated value to a storage device (not shown). The comparing unit 141 then generates a ratio relationship of the first calculated value and a preceding calculated value, and generates a first comparison result according to the ratio relationship and a threshold. If the first comparison result indicates that the ratio relationship is greater than the threshold, the counter value generated by the counting unit 142 is added by one. At a second time point (corresponding to a second frame), the channel response estimating circuit 110 to the calculating unit 130 perform the same processes to generate a second calculated value and to store the second calculated value to a storage device (not shown). The comparing unit 141 calculates another ratio relationship between the second calculated value and the first calculated value stored in the storage device according to the second calculated value and the first calculated value, and compares the another ratio relationship with a threshold to generate a second comparison result. If the second result indicates that the another ratio relationship is greater than the threshold, the counter value generated by the counting unit 142 is added by one. In this embodiment, one period may be set to be a plurality of frames, e.g., 20 or 40 frames are one period. The counter value accumulated in the period is then compared with a predetermined value, and the wireless channel is determined as time-varying if the accumulated result is greater than the predetermined value. It should be noted that, the orders of the steps in this embodiment are illustrative. In possible implementation, applications of different orders of the steps are also included within the scope of the present invention. Further, for example but not limited to, the time points corresponding to the first calculated value and the second calculated value may be spaced by one OFDM symbol or one frame.

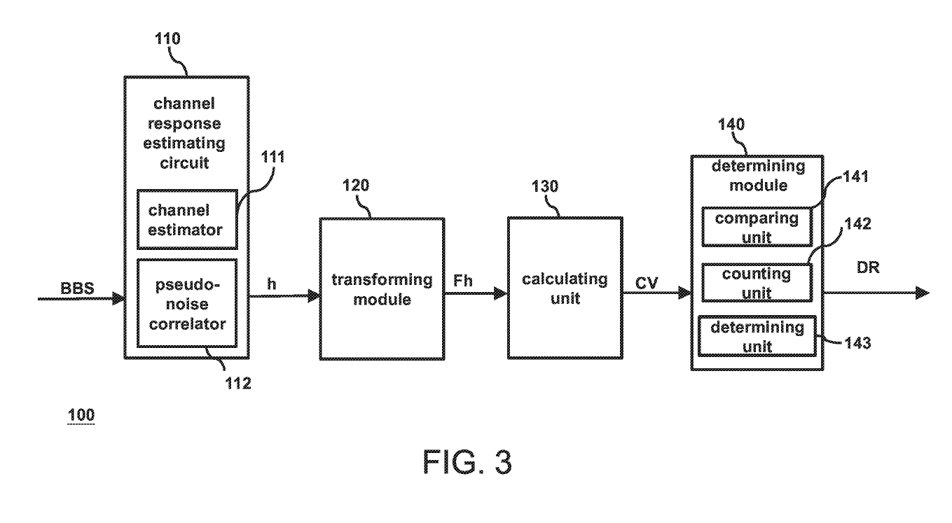

FIG. 3 shows a schematic diagram of the time-varying channel discriminating device 100 according to a third embodiment of the present invention. As shown in FIG. 3, the channel response estimating circuit 110 further includes a channel estimator 111 and a pseudo-noise correlator 112. Any two or all of the circuit may be integrated into one integrated circuit or may be independent circuits.

Referring to FIG. 3, in this embodiment, the time-varying channel discriminating device 100 is also located in a receiver of a DTMB system to receive a baseband signal. Further, the time-varying channel discriminating device 100 is operable in two modes—an acquisition mode and a tracking mode. In the acquisition mode, the pseudo-noise correlator 112 calculates a correlation result of the baseband signal and a pseudo-noise sequence to generate an estimated channel response. For example, the frame header of a signal frame of the DTMB system includes a pseudo-noise sequence, and a corresponding channel estimation is accordingly performed. Similarly, the estimated channel response is processed by the transforming unit 120, the calculating unit 130 and the determining unit 140 to generate a determination result, according to which it is determined whether the channel is in a time-varying channel state. In the tracking mode, the channel estimator 111 calculates the channel response corresponding to a subcarrier in the baseband signal to generate an estimated channel response. Similarly, the estimated channel response is processed by the transforming unit 120, the calculating unit 130 and the determining unit 140 to generate a determination result, according to which it is determined whether the channel is time-varying. Therefore, the DTMB system is capable of consistently performing time-varying channel discrimination in the acquisition mode and the tracking mode.

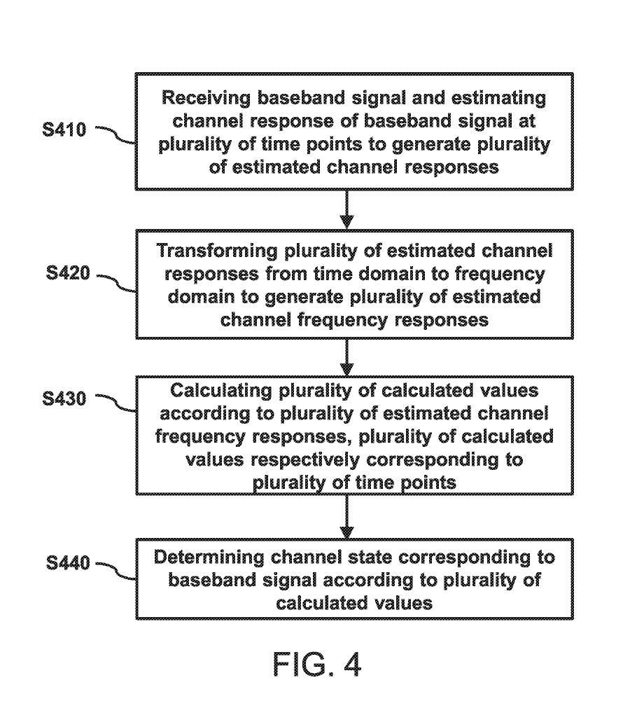

In addition to the foregoing device, the present invention correspondingly discloses a time-varying channel discriminating method, which is performed by the time-varying channel discriminating device 100 located in the receiver circuit of a wireless communications system or by an equivalent device. As shown in FIG. 4, the method according to an embodiment includes following steps.

In step S410, a baseband signal is received, and a channel response of the baseband signal is estimated at a plurality of time points to generate a plurality of estimated channel responses. This step may be performed by the channel response estimating circuit 110 in FIG. 1 or an equivalent circuit.

In step S420, the estimated channel responses are transformed from the time-domain to the frequency-domain to generate a plurality of estimated channel frequency responses. This step may be performed by the transforming unit 120 in FIG. 1 or an equivalent device. In one embodiment, this step further includes performing a fast Fourier transform (FFT) process.

In step S430, a plurality of calculated values are calculated according to the estimated channel frequency responses. The calculated values correspond to a plurality of time points, respectively. This step may be performed by the calculating unit 130 in FIG. 1 or an equivalent circuit.

In step S440, a channel state corresponding to the baseband signal is determined according to the calculated values. This step may be performed by the determining module 140 in FIG. 1 or an equivalent circuit. In one embodiment, this step further includes: calculating a ratio value of the calculated values; comparing the ratio value with a threshold to generate a plurality of comparison results; and generating a counter value according to the comparison results. If the counter value is greater than a predetermined value, the channel is determined as time-varying.

One person skilled in the art can understand details and variations of the method in FIG. 4 based on the disclosure of the devices in FIG. 1 to FIG. 3, and such repeated description is omitted herein.

In the channel discriminating device and method of the present invention, a baseband signal is received, a channel estimation is performed according to the baseband signal to generate estimated channel responses, and a transform from the time-domain to the frequency-domain is performed to obtain estimated channel frequency responses (i.e., observing characteristics that the estimated channel responses display on a spectrum). Calculated values of the channel responses are then obtained, analyzed, compared and statistically calculated to determine whether the channel is time-varying. Compared to the prior art, the calculation method of the present invention not only is simple, but also involves a low system computation amount and consumes a shorter calculation time. Thus, the wireless communication system is allowed to determine the channel state by a more economical approach and to correspondingly adjust the system.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A time-varying channel discriminating device, comprising:
a channel response estimating circuit, estimating channel response of a baseband signal at a plurality of time points to generate a plurality of estimated channel responses;
a transforming unit, transforming the plurality of estimated channel responses from a time domain to a frequency domain to generate a plurality of estimated channel frequency responses;
a calculating unit, calculating a plurality of calculated values according to the plurality of estimated channel frequency responses; and
a determining module, determining a channel state corresponding to the baseband signal according to the plurality of calculated values.

2. The time-varying channel discriminating device according to claim 1, wherein the determining module comprises:
a comparing unit, comparing a ratio relationship of the plurality of calculated values with a threshold to generate a plurality of comparison results;
a counting unit, generating a counter value according to the plurality of comparison results; and
a determining unit, determining whether the channel state of the baseband signal is a time-varying channel state according to the counter value.

3. The time-varying channel discriminating device according to claim 2, wherein the comparing unit generates a ratio value according to a first calculated value and a second calculated value of the plurality of calculated values, and compares the ratio value with the threshold to generate one of the plurality of comparison results; the first calculated value and the second calculated value correspond to a first time point and a second time point, respectively.

4. The time-varying channel discriminating device according to claim 2, wherein the channel is determined to be in the time-varying channel state when the counter value is greater than a predetermined value.

5. The time-varying channel discriminating device according to claim 1, wherein each of the calculated values is an energy value of a corresponding estimated channel frequency response of the estimated channel frequency responses.

6. The time-varying channel discriminating device according to claim 1, wherein the channel response estimating circuit comprises a channel estimator, which estimates the channel response of a subcarrier of the baseband signal at the plurality of time points to generate the plurality of estimated channel responses.

7. The time-varying channel discriminating device according to claim 1, wherein the channel response estimating circuit comprises a pseudo-noise correlator, which performs a correlation process on a plurality of pseudo-noise sequences of the baseband signal at the plurality of time points to generate the plurality of estimated channel responses.

8. The time-varying channel discriminating device according to claim 1, wherein the plurality of time points correspond to a plurality of symbols, respectively.

9. The time-varying channel discriminating device according to claim 1, wherein the plurality of time points correspond to a plurality of signal frames, respectively.

10. A time-varying channel discriminating method, performed by a receiver, comprising:
receiving a baseband signal, and estimating channel response of the baseband signal at a plurality of time points to generate a plurality of estimated channel responses;
transforming the plurality of estimated channel responses from a time domain to a frequency domain to generate a plurality of estimated channel frequency responses;
calculating a plurality of calculated values according to the plurality of estimated channel frequency responses; and
determining a channel state corresponding to the baseband signal according to the plurality of calculated values.

11. The time-varying channel discriminating method according to claim 10, wherein the step of determining the channel state of the baseband signal comprises:
comparing a ratio relationship of the plurality of calculated values with a threshold to generate a plurality of comparison results;
generating a counter value according to the plurality of comparison results; and
determining whether the channel state of the baseband signal is a time-varying channel state according to the counter value.

12. The time-varying channel discriminating method according to claim 11, wherein the step of generating the plurality of comparison results comprises:
generating a ratio value according to a first calculated value and a second calculated value of the plurality of calculated values; and
comparing the ratio value with the threshold to generate one of the plurality of comparison results;
wherein, the first calculated value and the second calculated value correspond to a first time point and a second time point, respectively.

13. The time-varying channel discriminating method according to claim 11, wherein the channel is determined to be in the time-varying channel state when the counter value is greater than a predetermined value.

14. The time-varying channel discriminating method according to claim 11, wherein each of the calculated values is an energy value of a corresponding estimated channel frequency response of the estimated channel frequency responses.

15. The time-varying channel discriminating method according to claim 10, wherein the step of generating the plurality of estimated channel responses comprises:
estimating the channel response of a subcarrier of the baseband signal at the plurality of time points to generate the plurality of estimated channel responses.

16. The time-varying channel discriminating method according to claim 10, wherein the step of generating the plurality of estimated channel responses comprises:
performing a correlation process on a plurality of pseudo-noise sequences of the baseband signal at the plurality of time points to generate the plurality of estimated channel responses.

17. The time-varying channel discriminating method according to claim 10, wherein the plurality of time points correspond to a plurality of symbols, respectively.

18. The time-varying channel discriminating method according to claim 10, wherein the plurality of time points correspond to a plurality of signal frames, respectively.
